(19) United States
(12) Patent Application Publication
(10) Pub. No.: US 2025/0294102 A1
(43) Pub. Date: Sep. 18, 2025

(54) MAINTENANCE ASSISTANCE METHOD, INFORMATION PROCESSING APPARATUS, AND MEDIUM

(71) Applicant: CANON KABUSHIKI KAISHA, Tokyo (JP)

(72) Inventor: KEISUKE NIIMOTO, Kanagawa (JP)

(21) Appl. No.: 19/078,810

(22) Filed: Mar. 13, 2025

(30) Foreign Application Priority Data
Mar. 15, 2024 (JP) 2024-041587

(51) Int. Cl. H04N 1/00; G06Q 10/20

(52) U.S. Cl. CPC H04N 1/00344; G06Q 10/20; H04N 1/00084; H04N 1/00411

(57) ABSTRACT

An information processing apparatus configured to cooperate with an image forming apparatus issues an instruction, in response to selection of an item that is included in a manual displayed by a display and is associated with a maintenance screen of the image forming apparatus displayed by the image forming apparatus on a display of the image forming apparatus, to the image forming apparatus to transmit screen information of the maintenance screen associated with the item for each role of the worker who performed the selection. The information processing apparatus displays the maintenance screen on the display based on the screen information transmitted by the image forming apparatus in response to the instruction.

### BACKGROUND

### Field of the Disclosure

The present disclosure relates to a maintenance assistance method, an information processing apparatus, and a medium for providing maintenance assistance for an image forming apparatus.

### Description of the Related Art

In the field of commercial printing, downtime of an image forming apparatus directly translates into losses, and therefore a high rate of operation is required. For this reason, when maintenance or an error occurs, minor tasks are handled by an operator, but if the operator is unable to handle a task, a maintenance worker is dispatched to the location where the image forming apparatus is installed to handle the task. Maintenance workers are required to act faster to suppress losses caused by downtime.

In order to improve the efficiency of the work of a maintenance worker, there is a maintenance assistance system that assists maintenance work by displaying errors and maintenance items that the maintenance worker is to handle as a work list. When a maintenance worker selects a task to perform from this work list, he or she can refer to a service manual that describes the procedure for the task, allowing for more efficient maintenance work.

In addition, in some cases, maintenance workers are divided into levels according to their authority and skill, and minor tasks are handled by maintenance specialists who have been trained at a customer's location, instead of by conventional customer engineers dispatched from a service center or the like. In this way, maintenance operations are carried out efficiently while reducing the cost of dispatching workers.

As a proposal for efficiently performing actual work with a manual, for example, Japanese Patent Laid-Open No. 2019-109722 presents a method of disposing a link icon linking a manual and a corresponding operation screen on an operation panel of an image forming apparatus. In this proposal, a browser that displays a manual acquired from a Web server is installed on the same image forming apparatus as the operation screen, making it easy to switch between the manual and the corresponding operation screen.

However, in a maintenance assistance system, a service tool for providing maintenance assistance is often installed in an external apparatus separate from the image forming apparatus, in which case switching as described in Japanese Patent Laid-Open No. 2019-109722 cannot be performed. For this reason, when the service tool is installed in an external apparatus, in order to perform work in accordance with a service manual, it has been necessary to go back and forth between the operation panels of the apparatuses and perform operations by entering the desired screen from the menu of the image forming apparatus. The problem with this method is that it reduces work efficiency.

In addition, the operation panel of an image forming apparatus often has a smaller display area and is less user-friendly than a typical external apparatus, which is another factor that reduces work efficiency.

### SUMMARY

The present disclosure provides an environment in which an image forming apparatus can be efficiently operated from a service manual on a service tool even when the apparatus in which the service tool is installed is different from the image forming apparatus.

An aspect of the present disclosure provides an information processing apparatus configured to cooperate with an image forming apparatus, comprising: a display; a storage holding a role of a worker during work; at least one memory storing instructions; and at least one processor that is in communication with the at least one memory and that, when executing the instructions, cooperates with the at least one memory to execute processing, the processing including issuing an instruction, in response to selection of an item that is included in a manual displayed by the display and is associated with a maintenance screen of the image forming apparatus displayed by the image forming apparatus on a display of the image forming apparatus, to the image forming apparatus to transmit screen information of the maintenance screen associated with the item for each role of the worker who performed the selection; and displaying the maintenance screen on the display based on the screen information transmitted by the image forming apparatus in response to the instruction.

Further features of various embodiments will become apparent from the following description of exemplary embodiments with reference to the attached drawings.

### BRIEF DESCRIPTION OF THE DRAWINGS

FIG. 1 is a block diagram showing an entire maintenance assistance system according to a first embodiment and a second embodiment.

FIG. 2 is a hardware configuration diagram of an information processing apparatus and a maintenance service terminal according to the first embodiment and the second embodiment.

FIG. 3 is a diagram showing functional blocks of the maintenance service terminal and the information processing apparatus according to the first embodiment and the second embodiment.

FIG. 4 is a diagram showing functional blocks of an image forming apparatus according to the first embodiment and the second embodiment.

FIG. 5 is a diagram showing an example of a screen configuration in a service mode according to the first embodiment and the second embodiment.

FIG. 6 is a diagram showing command definitions for transition screens according to the first embodiment.

FIG. 7 is a diagram showing an example of a service manual in the first embodiment and the second embodiment.

FIG. 8 is a diagram showing transition destination definitions for service mode links in the first embodiment.

FIG. 9 is a flowchart showing processing for transition to a service mode in the first embodiment.

FIG. 10 is a diagram showing an example of screen transition on a maintenance service terminal in the first embodiment and the second embodiment.

FIGS. 11A and 11B are diagrams showing definitions of virtual buttons for transition screens in the second embodiment.

FIG. 12 is a diagram showing transition destination definitions for service mode links in the second embodiment.

FIG. 13 is a flowchart showing processing for transition to a service mode in the second embodiment.

### DESCRIPTION OF THE EMBODIMENTS

Hereinafter, embodiments will be described in detail with reference to the attached drawings. Note, the following embodiments are not intended to limit the scope of every embodiment. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

### First Embodiment

### System Configuration

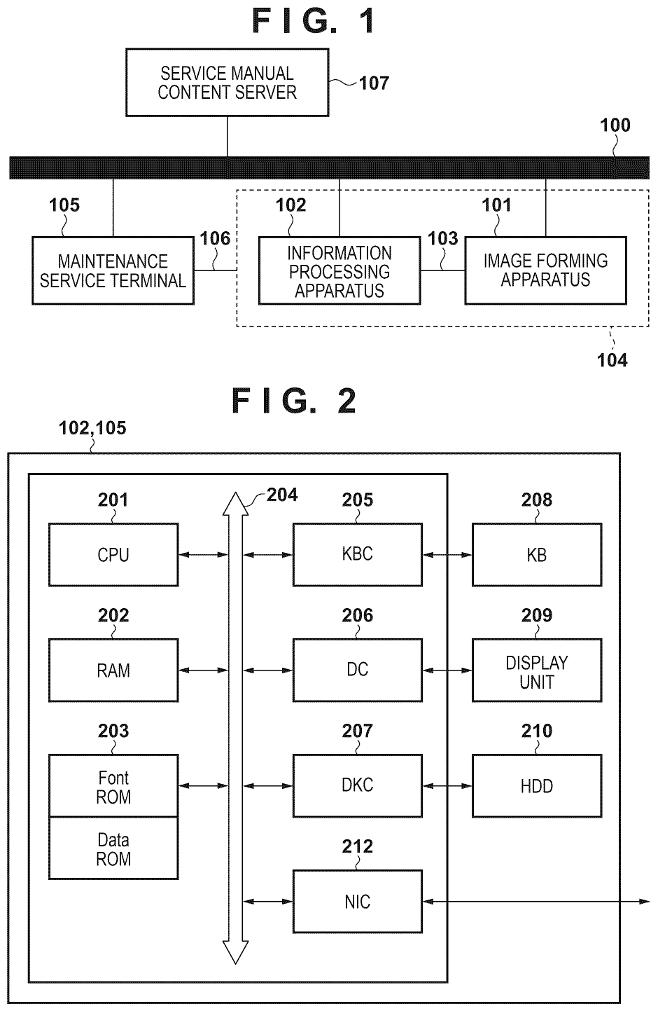

FIG. 1 is a block diagram showing a maintenance assistance system according to this embodiment. The maintenance assistance system includes a printing company system 104, a maintenance service terminal 105, and a service manual content server 107, which are all connected to each other via the Internet 100. The printing company system 104 includes an image forming apparatus 101 and an information processing apparatus 102, both of which are connected via a connection 103. This connection 103 may be a local connection such as a local network or USB connection, or may be a connection via the Internet. In addition, the printing company system 104 and the maintenance service terminal 105 are connected by a local connection 106 such as a local network or a USB connection. The local connection 106 may connect, for example, each of the image forming apparatus 101 and the information processing apparatus 102 of the printing company system 104 to the maintenance service terminal 105. Also, the local connection 106 may connect either the image forming apparatus 101 or the information processing apparatus 102 of the printing company system 104 to the maintenance service terminal 105, and the other apparatus may be connected to the maintenance service terminal 105 via the connection 103.

The image forming apparatus 101 is controlled under the control of a group of programs operating on the information processing apparatus 102, processes print data in accordance with a print setting, and produces a deliverable product. The deliverable product is printed material produced by a printing company, and may include printed material that has been subjected to post-processing according to an order, such as cutting and binding. The maintenance service terminal 105 communicates with the printing company system 104 to monitor the state of the image forming apparatus 101 and acquire device information necessary for maintenance work. The information is then used by a service tool installed in the maintenance service terminal 105 to provide a maintenance assistance service for a maintenance worker. When a document for the maintenance worker, such as a service manual, is to be displayed, the maintenance service terminal 105 can download the service manual from the service manual content server 107 to the maintenance service terminal 105. The downloaded service manual is displayed on the maintenance service terminal 105, allowing the maintenance worker to view the service manual.

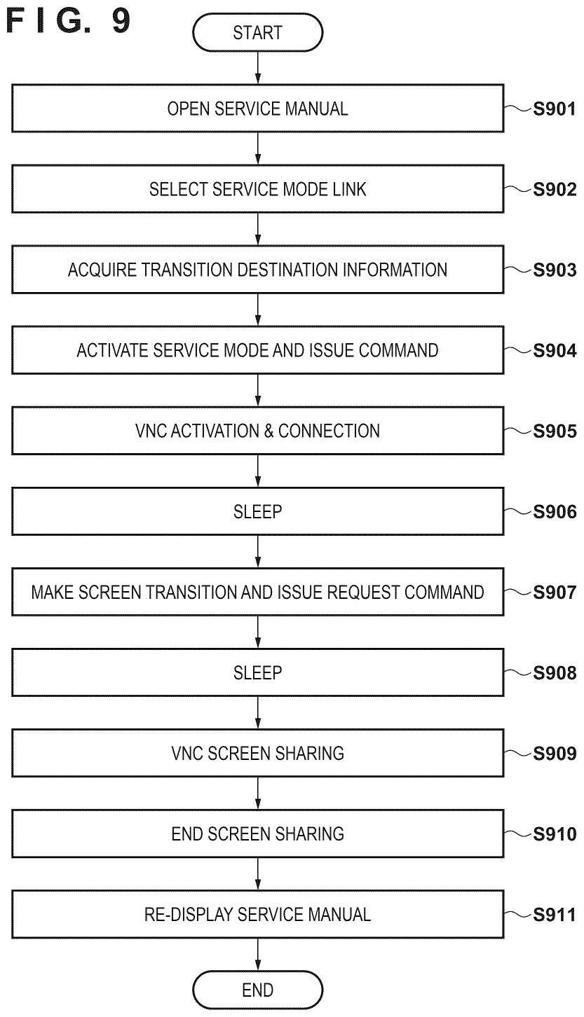

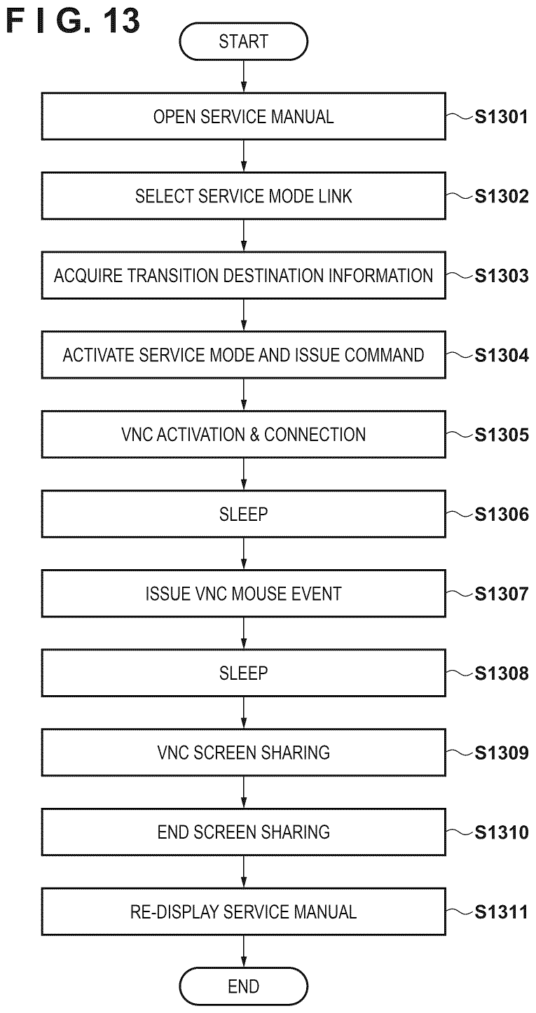

FIG. 2 is a block diagram showing a configuration of the information processing apparatus 102 and the maintenance service terminal 105. In FIG. 2, a CPU 201 executes an OS or a general application program stored in a program ROM of a ROM 203 or loaded from an HDD 210 to a RAM 202. The program to be executed includes a program for implementing the procedures of the flowcharts shown in FIG. 9 and FIG. 13. The ROM 203 includes a font ROM and a data ROM. The RAM 202 functions as a main memory, a work area, and the like for the CPU 201. A keyboard controller (KBC) 205 controls input from a keyboard (KB) 208 and a pointing device (not shown). A display controller (DC) 206 controls display on a display unit 209. A disk controller (DKC) 207 controls access to an HDD 210 that stores a boot program, various applications, font data, and the like. A network controller (NIC) 212 is connected to a network and executes communication control processing with other devices connected to the network. A bus 204 connects the CPU 201, the RAM 202, the ROM 203, various controllers, and the like and conveys data signals and control signals.

Note that the configuration includes a touch panel controller or the like instead of the keyboard controller (KBC) 205 in some cases. In such a case, a touch panel may be provided integrally with the display unit 209. In addition, a large-capacity storage apparatus may be provided instead of the HDD 210. Furthermore, the internal configuration of the network controller (NIC) 212 differs depending on whether the included apparatus is a wired LAN, a wireless LAN, or both. However, these differences due to the internal configuration are concealed within the network controller (NIC) 212, and the other modules shown in FIG. 2 are configured as equivalent modules so as to be able to control the system.

The image forming apparatus 101 may have the same hardware for control as that shown in FIG. 2, but further includes a printer unit, which is a printing mechanism, a post-processing unit for post-processing, and a controller for these units. Depending on the configuration, the image forming apparatus 101 can execute, for example, a remote desktop server and provide a UI screen to a client terminal, thereby realizing a so-called remote UI. In this case, the client terminal may be the maintenance service terminal 105.

### Functional Blocks of Maintenance Service Terminal

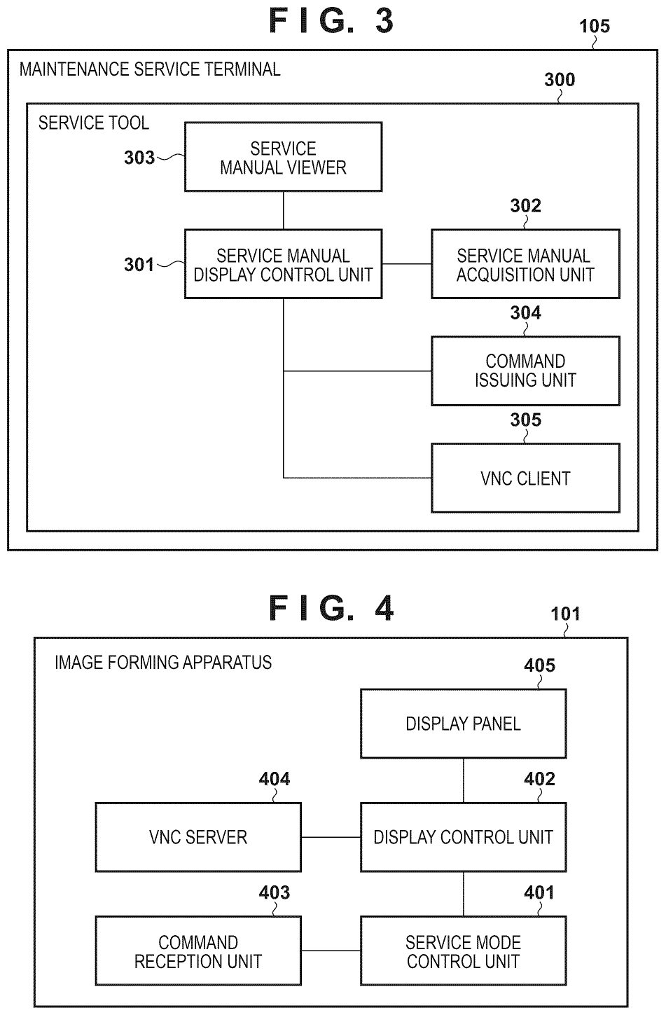

FIG. 3 is a diagram showing functional blocks of the maintenance service terminal 105 included in the maintenance assistance system according to this embodiment. Each functional block is a software module that is realized by the CPU 201 of the maintenance service terminal 105 executing a program stored in the memory. A service tool 300 is installed in the maintenance service terminal 105. The service tool 300 is an application that provides a maintenance worker with a function of supporting maintenance and inspection, such as displaying a service manual for maintenance and inspection of the image forming apparatus 101. Note that in this embodiment, the maintenance service terminal 105 has the service tool 300, but the information processing apparatus 102 may also have the service tool 300, and the service tool 300 can also be built-in in the image forming apparatus 101.

The service tool 300 includes a service manual display control unit 301 that controls display of the service manual referred to by the maintenance worker, and a service manual acquisition unit 302 that acquires the service manual from the service manual content server 107. The service tool 300 further includes a service manual viewer 303 for displaying the acquired service manual. The service tool 300 further includes a command issuing unit 304 that issues commands to the image forming apparatus, and a VNC client 305 for remote connection or remote operation using Virtual Network Computing (VNC). The VNC client is also called a remote operation client, and the VNC server (described below), which is paired with the VNC client, is also called a remote operation server.

When the service tool 300 displays a service manual, the service manual display control unit 301 requests the service manual acquisition unit 302 to acquire the content of the service manual. The service manual acquisition unit 302 acquires the service manual from the service manual content server 107 via the Internet 100. In this case, the format acquired from the service manual content server 107 may be a general markup format such as HTML, or may be a unique format without being limited thereto. Based on the service manual acquired by the service manual acquisition unit 302, the service manual display control unit 301 instructs the service manual viewer 303 to display the service manual. The service manual viewer 303 uses the display controller 206 of the maintenance service terminal 105 to display the service manual for which display has been instructed, on the display unit 209. Note that an example of the service manual will be described later with reference to FIG. 7. The service manual display control unit 301 controls the display of the service manual displayed on the display unit 209 in accordance with keyboard input and pointing device input that are input to the keyboard controller (KBC) 205 of the maintenance service terminal 105. For example, when a maintenance worker selects a link to another service manual or a link to a service mode, the service manual display control unit 301 controls switching to the link destination. Through the switching operation, the service manual display control unit 301 instructs the service manual viewer 303 to display content such as the service manual, service mode, and the like of the link destination. Note that in this embodiment, the service mode is an operation mode corresponding to services such as maintenance and inspection of the image forming apparatus 101, and the maintenance screen displayed on the display panel of the image forming apparatus 101 for the service mode is a service mode screen.

The command issuing unit 304 is a module that performs command communication with the image forming apparatus 101, and issues a command to the image forming apparatus 101 via the Internet 100 in accordance with a predetermined command definition. Communication realized by issuing a command is called command communication, and cooperation between apparatuses through command communication, such as cooperation between the maintenance service terminal 105 and the image forming apparatus 101, is called command cooperation. When the service manual display control unit 301 performs command cooperation with the image forming apparatus 101, the service manual display control unit 301 performs the command cooperation using the command issuing unit 304. The VNC client 305 is a module that performs client control for remote connection using a general RFB protocol. In the RFB protocol, a message regarding an area of interest in a display frame or input events such as those of the keyboard or pointer are transmitted from the client to the server, and messages such as an update to the display frame in response to an input event is transmitted from the server to the client. VNC is software that implements such an RFB protocol to realize a remote desktop. In this embodiment, VNC is used as the remote connection, but there is no limitation to this, and RDP or the like may also be used.

The VNC client 305 provides a general remote connection function by communicating with a later-described VNC server 404 installed in the image forming apparatus 101. The functions provided include, for example, transfer of keyboard input and pointing device input, and display of a screen sent from the VNC server 404 on the display unit 209 of the maintenance service terminal 105. When the service manual display control unit 301 performs remote connection with the image forming apparatus 101, the service manual display control unit 301 does so using the VNC client 305.

### Functional Blocks of Image Forming Apparatus

FIG. 4 is a diagram showing functional blocks of the image forming apparatus 101 included in the maintenance assistance system according to this embodiment. Each functional block other than a display panel 405 is a software module that is realized by the CPU 201 of the image forming apparatus 101 executing a program stored in a memory. The image forming apparatus 101 includes a service mode control unit 401, a display control unit 402, a command reception unit 403, a VNC server 404, and the display panel 405, which is a display unit.

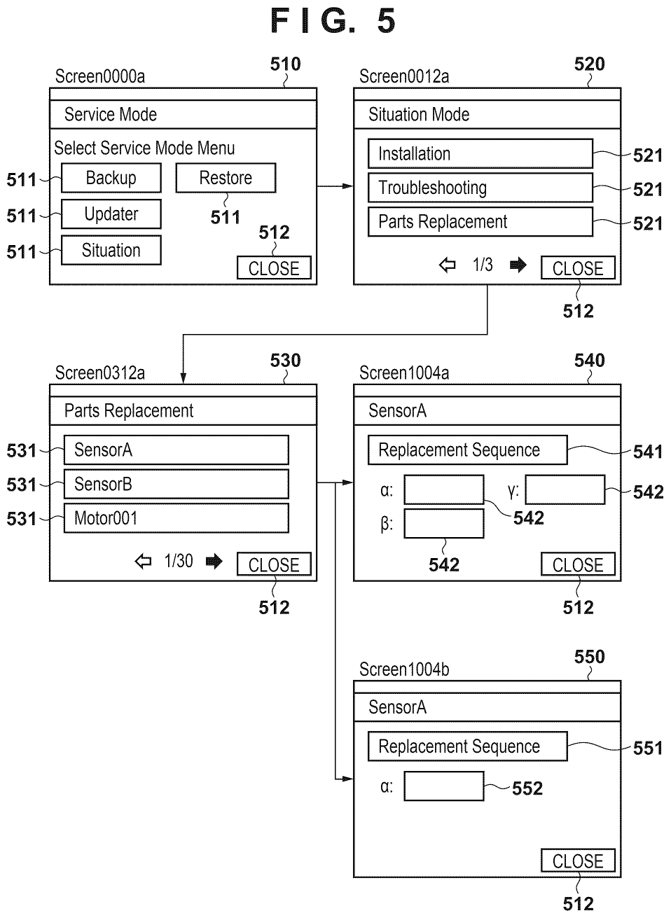

The service mode control unit 401 controls a service mode for performing maintenance work, and controls activation of the service mode and each function. When the service mode is activated, the service mode control unit 401 requests the display control unit 402 to display a service mode screen (FIG. 5, described later). The display control unit 402 displays the screen of the requested service mode on the display panel 405 of the image forming apparatus 101.

The command reception unit 403 is a module that performs command communication with the maintenance service terminal 105, and receives commands that conform to a set command definition from the maintenance service terminal 105 via the Internet 100. When a command requesting switching to the service mode is received from the maintenance service terminal 105, the command reception unit 403 transmits the request to the service mode control unit 401, and the service mode control unit 401 activates the service mode and switches the screen display. The VNC server 404 is a module that performs server control for remote connection using the general RFB protocol. In this embodiment, VNC is used as the remote connection, but there is no limitation to this, and RDP or the like may also be used. The VNC server 404 communicates with the VNC client 305 to provide a general remote connection function, such as transferring a screen and controlling received keyboard inputs and pointing device inputs as inputs to the image forming apparatus 101. The display control unit 402 receives keyboard inputs and pointing device inputs via the VNC server 404, and performs display control in accordance with the inputs.

### Configuration Example of Service Mode Screen

FIG. 5 shows an example of a configuration of a service mode screen controlled by the service mode control unit 401. The service mode screen 510 is a top menu screen that is displayed first when the service mode control unit 401 activates the service mode. When a maintenance worker selects a menu item button 511 on the service mode screen 510, the screen transitions to a service mode screen 520 that corresponds to the selection. FIG. 5 shows an example of a screen that appears when a Situation button is selected. Detailed menu item buttons 521 are arranged on the service mode screen 520, and the maintenance worker can select a desired menu item to transition to a service mode screen 530. The service mode screen 530 is an example of a screen that appears when Parts Replacement is selected on the service mode screen 520. The service mode screen 530 has buttons 531 arranged on the screen as a list of replacement parts, and the maintenance worker can select a desired replacement part. When the maintenance worker selects a desired replacement part on the service mode screen 530, the next screen transition will depend on the role and authority of the maintenance worker performing the work. The role and authority of the maintenance worker may be determined by a method of identifying a physical authentication key, or by a method of inputting an authentication key on a screen. For example, if the role and authority are linked to identification information of the maintenance worker, it is possible to specify the role or authority of the authenticated maintenance worker. The authentication of the maintenance worker may be performed prior to referring to the service manual. In the case of a customer engineer (hereinafter abbreviated as CE) who has a higher role and authority, the screen transitions to a service mode screen 540 in response to the selection of SensorA (sensor A). In addition to a button 541 for starting a sequence for replacing the selected part, the service mode screen 540 also has input areas 542 for respective adjustment value parameters α, β, and γ that are to be input before and after the replacement sequence.

On the other hand, in the case of a maintenance specialist (hereinafter abbreviated as MS) with a lower role and authority, the screen transitions to a service mode screen 550 in response to the selection of SensorA (sensor A). The service mode screen 550 is the same as the service mode screen 540 for a CE in that, in addition to a button 551 for starting the replacement sequence for the selected part, it also has an input area 552 for an adjustment value parameter α that is to be entered before and after the replacement sequence. However, the parameters that can be entered in the adjustment value parameter input area 552 are limited to an item α in accordance with the role and authority of an MS, there is no input area for the adjustment value parameters β and γ for a CE, and the input area 552 is smaller in number than the input areas 542.

Note that when ending the service mode, a close button 512 disposed on each service mode screen is selected, and the service mode control unit 401 ends the service mode and returns to the normal mode.

### Example of Command Definitions

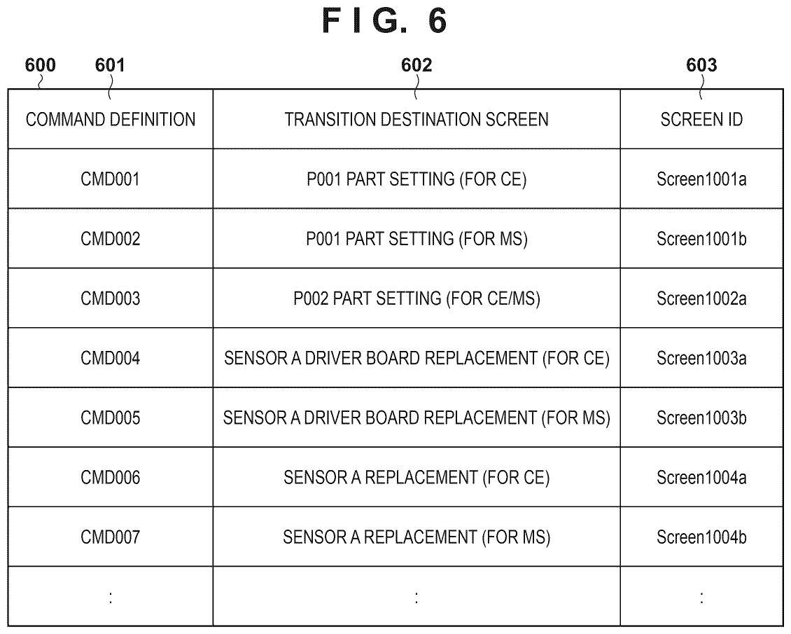

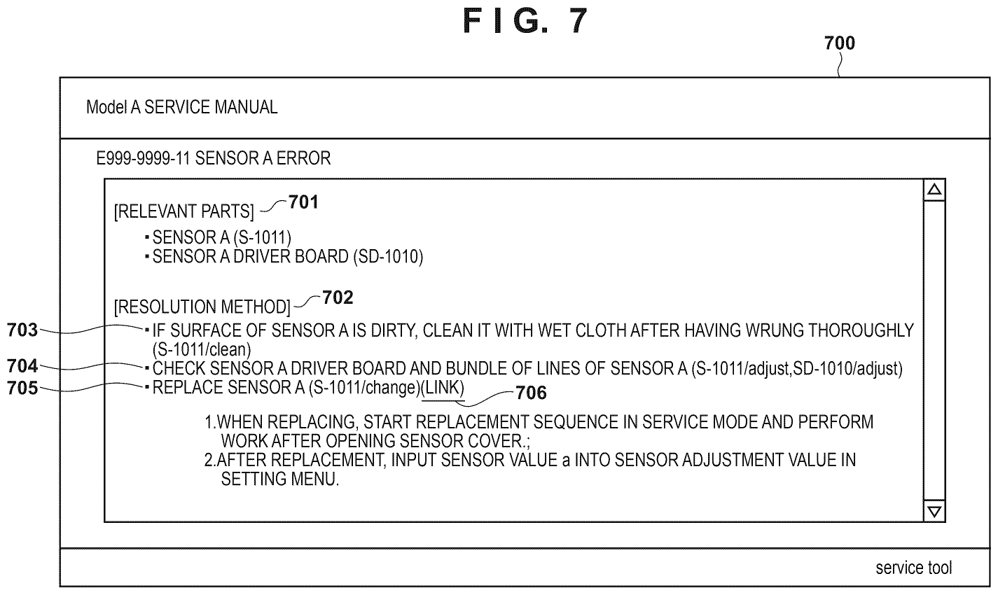

FIG. 6 shows an example of command definitions used by the command issuing unit 304 and the command reception unit 403. A command definition 600 defines command parameters associated with transition destination screens of the service mode, such as the service mode screens 540 and 550.

The command definition column 601 contains definition values defined between the command issuing unit 304 and the command reception unit 403, and a transition destination screen for each service mode is assigned to each definition value in a transition destination screen column 602 and a screen ID column 603. In the transition destination screen column 602, the screen name of the transition destination screen is linked, and in the screen ID column 603, an ID determined uniquely among the service mode screens is linked as a command definition. A command definition table indicating these definitions is internally held by the command issuing unit 304 and the command reception unit 403. For example, a command called CMD005 is associated with a screen named “Sensor A driver board replacement (for MS)” and given an ID, that is, identification information, called Screen 1003b, in the transition destination screen column 602.

### Service Manual

FIG. 7 shows an example of a service manual displayed on the service manual viewer 303 of the maintenance service terminal 105. A service manual 700 is constituted by relevant parts 701 and a resolution method 702. The relevant parts 701 lists parts relevant to the error or maintenance item. That is, the parts can be considered to be parts that may be causing an error.

The resolution method 702 describes a procedure for dealing with the error or maintenance item, and if there are a plurality of causes of errors or a plurality of maintenance tasks, a plurality of resolution methods are described, such as a resolution method 703, a resolution method 704, and a resolution method 705. In this embodiment, the procedure is described using only text, but the procedure may also be illustrated by providing an image or video in the resolution method. The resolution method 705 is a procedure that requires operation in a service mode of the image forming apparatus 101, and a service mode link 706 for transitioning to the service mode screen is provided therein. In FIG. 7, “Link” is displayed to make it clear that it is a link, but the link may be embedded in information such as a string of characters or object of a matter or item described in document information (here, the service manual), and the presence of the link may be indicated through a display mode such as color. When the maintenance worker selects this service mode link 706, the service manual display control unit 301 activates the VNC client 305, and a service mode screen on which operation is required is displayed on the display unit 209 of the maintenance service terminal 105.

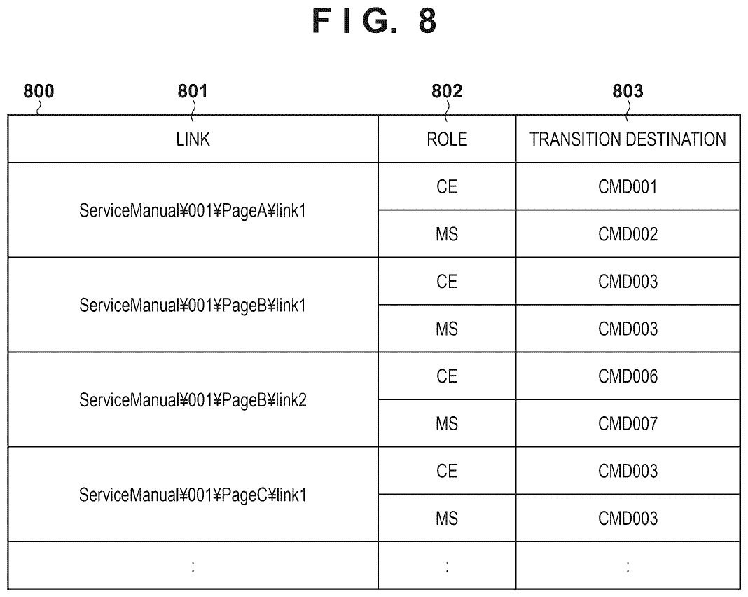

FIG. 8 shows an example of a transition destination definition table 800 that defines service mode screens to which a transition occurs when the service mode link 706 is selected. This transition destination definition table 800 is acquired together with the service manual by the service manual acquisition unit 302 from the service manual content server 107. A link definition column 801 lists all of the service mode links 706 in the service manual. For each field of the link definition column 801, a command definition 601 defined in FIG. 6 is assigned for each maintenance worker role (role column 802), and transition destination screens are defined (transition destination column 803). This makes it possible to obtain the command definition of the transition destination screen when the service mode link 706 is selected. The service manual display control unit 301 passes the command definition indicating this transition destination 803 to the command issuing unit 304, and issues a command to request the image forming apparatus 101 to make a screen transition. Upon receiving the command, the image forming apparatus 101 refers to the command definition 600 in FIG. 6, for example, to specify a transition destination screen, such as a service mode screen, and transmits the screen information to the maintenance service terminal 105 as a remote UI. The maintenance service terminal 105 displays a transition destination screen, such as a service mode screen, based on the received screen information. This enables skipping of the service mode screen transition flow shown in FIG. 5 and transitioning directly to the desired service mode screen.

For example, if the selected link is ServiceManual¥001¥PageB¥link2 (the third line in FIG. 8), and if the role of the authenticated maintenance worker is CE, CMD006 is obtained from the transition destination definition table 800, and if the role of the authenticated maintenance worker is MS, CMD007 is obtained. When the obtained command is transmitted to the image forming apparatus 101, the image forming apparatus 101 transmits, to the maintenance service terminal 105, the screen of Screen 1004a if the received command is CMD006, or the screen of Screen 1004b if the received command is CMD007. The maintenance service terminal 105 displays the received screen on the display unit 209.

### Example of Processing Procedure of Maintenance Work

FIG. 9 is a flowchart showing a flow of processing regarding a screen transition from the service manual to the service mode on the maintenance service terminal 105. Prior to the start of this flow, the worker is authenticated and logs into the maintenance service terminal 105 or logs into the maintenance assistance system through the terminal. Also, the procedure of FIG. 9 is realized by the maintenance service terminal 105, or more specifically, by the CPU 201 thereof executing a program stored in a memory such as the RAM 202. However, in the following description, the software modules shown in FIG. 3 will be described as the entities that execute each step.

First, in step S901, the service manual viewer 303 of the maintenance service terminal 105 displays the service manual in response to an operation performed by the maintenance worker. In order to perform work in the service mode, the maintenance worker can select the service mode link 706 on the displayed service manual. In step S902, the service manual display control unit 301 receives the selection of the service mode link 706. The service mode link 706 is selected in step S902 depending on the needs of the work, and may also not be selected. In step S903 and subsequent steps, the processing performed when the service mode link 706 is selected will be described. In response to the selection of the service mode link 706, in step S903, the service manual display control unit 301 acquires the command definition value 803 of the transition destination screen from the transition destination definition table 800 in FIG. 8. In this example, it is assumed that a maintenance worker whose role is CE selects “link2” in the service manual called “ServiceManual¥001¥PageB”, and the command definition value of “CMD006” is obtained as the transition destination.

Next, in step S904, the service manual display control unit 301 requests the image forming apparatus 101 to activate the service mode via the command issuing unit 304 in order to transition the screen to the service mode screen. At the same time, the service manual display control unit 301 instructs the service manual viewer 303 to display a screen indicating that processing is in progress.

In step S905, the VNC client 305 is activated and a VNC connection with the VNC server 404 is started. In step S906, the service manual display control unit 301 performs sleep processing to wait for service mode activation in the image forming apparatus 101 after step S905. The sleep processing stops processing for a designated period of time, for example, and waits for activation of the service mode. After waiting, in step S907, the service manual display control unit 301 requests the image forming apparatus 101 to transition to the service mode screen, via the command issuing unit 304. At this time, the transition destination screen is designated by adding “CMD006”, which is the command definition value of the transition destination screen acquired in step S903, to the command. Upon receiving the command requesting transition of the service mode screen, the image forming apparatus 101 acquires the transition destination screen ID “Screen1004a” indicated by “CMD006” according to the command definition 600. Then, the service mode control unit 401 performs control so as to transition to the service mode screen of “Screen1004a”. At this time, it is assumed that the image forming apparatus 101 displays the service mode screen on the display unit of the image forming apparatus 101, but there is no limitation to this, and the screen information of the service mode screen may also be transmitted to the maintenance service terminal 105, without displaying the service mode screen on the display unit of the image forming apparatus 101. In step S908, the service manual display control unit 301 performs sleep processing to wait for the screen transition of the image forming apparatus 101 after step S907. After waiting, in step S909, the service manual display control unit 301 starts screen sharing via a VNC connection. In screen sharing, the maintenance service terminal 105 receives, via the VNC client 305, the service mode screen “Screen1004a” displayed on the image forming apparatus 101 and provided by the VNC server 404 of the image forming apparatus 101. Then, the service mode screen “Screen 1004a” displayed on the image forming apparatus 101 is displayed on the display unit 209 of the maintenance service terminal 105.

On the service mode screen displayed on the maintenance service terminal 105, the worker can perform input in the same manner as on the service mode screen displayed on the image forming apparatus 101. An input event is transmitted to the image forming apparatus 101 via the VNC client 305 and the VNC server 404, and the image forming apparatus 101 executes processing corresponding to the input event. For example, it is possible to set input parameters. In this manner, the maintenance work progresses while the service mode screen is displayed on the maintenance service terminal 105.

When the close button 512 is selected on the service mode screen by touch or the like, in step S910, the service manual display control unit 301 ends the screen sharing via VNC, and in step S911, re-displays the service manual that was displayed in step S902.

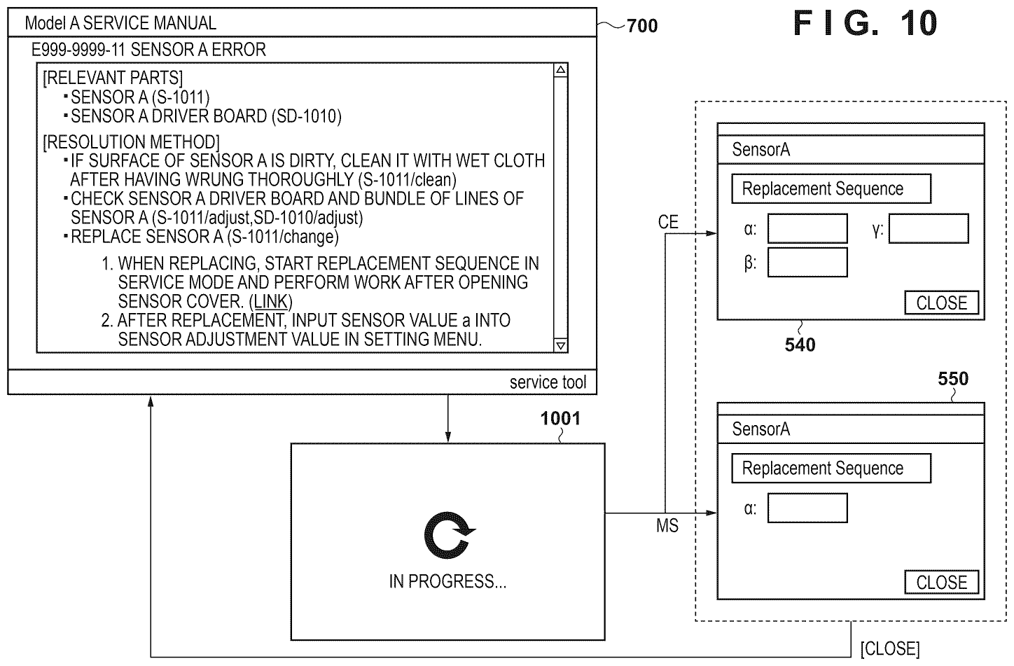

FIG. 10 is an example of a screen flow showing display switching from the service manual to the service mode on the maintenance service terminal 105, and will be described in conjunction with the steps of FIG. 9.

First, a screen 700 in FIG. 10 is a screen displaying the service manual described with reference to FIG. 7, and is displayed when the maintenance worker opens the service manual on the maintenance service terminal 105 in step S901. The maintenance worker performs the work while referring to the resolution method 702 in the displayed service manual, and selects the service mode link 706 when performing the work in the service mode of the image forming apparatus 101.

Next, when the service mode link 706 is selected, a processing screen 1001 is displayed. In step S903, in response to the service manual display control unit 301 instructing the service manual viewer 303 to display a screen indicating that processing is in progress, this processing screen 1001 is transitioned to.

Next, depending on the role and authority of the maintenance worker, the screen 540 or the screen 550 is displayed. The screen 540 in FIG. 10 is the service mode screen “Screen 1004a” for the CE described with reference to FIG. 5, and is a screen that requires the CE to perform work such as starting a part replacement sequence and inputting adjustment value parameters. If the role of the maintenance worker who selected the link in step S902 is CE, then in step S909, screen sharing via VNC with the VNC server 404 starts, and the screen transitions to this service mode screen 540. In addition, if the role of the maintenance worker who selected the link in step S902 is MS, the command definition value of the transition destination screen acquired in step S903 is “CMD007”, and this command definition value is used to issue a command to the image forming apparatus 101 in step S907. As a result, the screen ID of the transition destination becomes “Screen1004b”, and the image forming apparatus 101 performs control to transition to that screen. This causes a screen transition from the service manual screen 700 to the service mode screen 550, which is the service mode screen “Screen 1004b” for the MS.

Finally, when the maintenance worker finishes working on the service mode screen and selects CLOSE, the VNC connection is ended. By doing so, the VNC screen on the display unit 209 of the maintenance service terminal 105 is closed, and the display returns to the service manual screen 700 that was displayed before the service mode link 706 was selected.

With the above configuration and procedure, the link embedded in the service manual is associated with the service mode screen of the image forming apparatus. The associated service mode screen is then shared with the terminal and displayed on the terminal using, for example, a remote desktop function. This allows a seamless transition from the service manual to the operation screen of the image forming apparatus, even if the apparatus on which a service tool for maintenance assistance, such as a service manual viewer, is installed is different from the image forming apparatus. This provides an environment in which maintenance work can be performed efficiently.

Furthermore, depending on the role and authority associated with the maintenance worker, the transition destination operation screen associated with the link selected in the service manual can be set. This makes it possible to guide the maintenance worker to the maintenance work appropriate for his or her role or authority, and enables the maintenance work to be performed efficiently and without error.

### Second Embodiment

In the first embodiment, when the service manual display control unit 301 requests the image forming apparatus 101 to perform a screen transition, the transition destination screen is designated by transmitting a predetermined command definition value shown in FIG. 6 as a command. In addition to the method using such a command definition defined in advance, a method of arranging virtual buttons and designating a virtual button by a mouse event is also conceivable. In the second embodiment, an embodiment using this virtual button will be described.

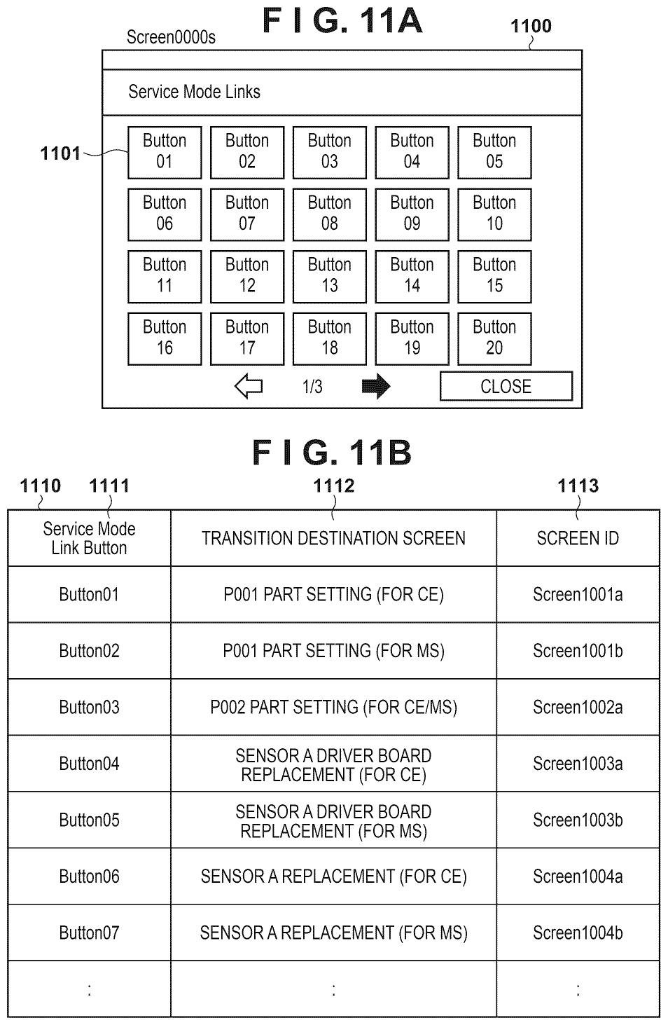

FIGS. 11A and 11B show an example of definitions for the service manual display control unit 301 to request the image forming apparatus 101 to perform a screen transition, using a VNC connection. A virtual screen 1100 in FIG. 11A is an example of a screen of virtual buttons implemented in the service mode control unit 401 of the image forming apparatus 101. This screen is called up, that is, displayed, by the image forming apparatus 101 when the maintenance service terminal 105 requests activation of the service mode. However, this virtual screen 1100 is a virtual screen, and no image is actually rendered on the display panel 405 of the image forming apparatus 101, and thus the maintenance worker does not see it. A plurality of virtual buttons 1101 are arranged on this virtual screen 1100, and the screen transition destination transitioned to when each virtual button is pressed is defined by a virtual button transition destination definition 1110 in FIG. 11B. This transition destination definition 1110 is also held by the service mode control unit 401 of the image forming apparatus 101. In the transition destination definition 1110, a service mode link button column 1111 lists the virtual buttons 1101 arranged on the virtual screen 1100. For each virtual button, a transition destination screen of each service mode is assigned in a transition destination screen column 1112 and a screen ID column 1113. The transition destination screen column 1112 indicates the screen name of the transition destination screen, and the screen ID column 1113 indicates an ID (identification information) determined uniquely among the service mode screens. In this manner, the transition destination definition 1110 may be a table that associates virtual buttons with transition destination screens.

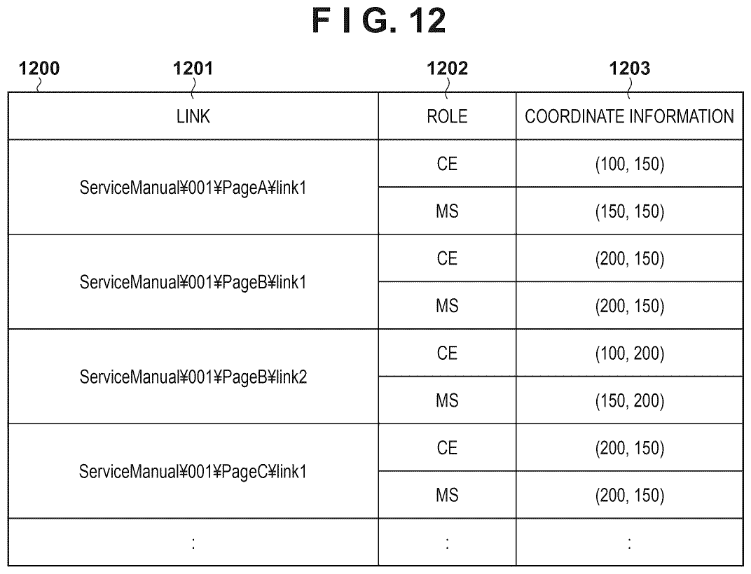

FIG. 12 shows a transition destination definition table 1200. The transition destination definition table 1200 is a table that defines coordinate information of virtual buttons according to the role of the maintenance worker when the service mode link 706 is selected. This transition destination definition table 1200 is acquired by the service manual acquisition unit 302 from the service manual content server 107 together with the service manual. The link definition column 1201 lists all of the service mode links 706 in the service manual. For the link definition column 1201, one of the virtual buttons 1101 defined in FIG. 11A and FIG. 11B is assigned to each maintenance worker role (role column 1202), and the coordinate information of the virtual button 1101 is embedded (coordinate information column 1203). As a result, when the service mode link 706 is selected, coordinate information 1203 of the virtual button 1101 pointing to the transition destination screen can be obtained.

The service manual display control unit 301 passes this coordinate information 1203 to the VNC client 305, and issues a VNC mouse event indicating that the coordinates have been clicked. Upon receiving the VNC mouse event, the image forming apparatus 101 determines that the virtual button 1101 corresponding to the coordinate information has been pressed, and executes the screen transition processing assigned to the pressed virtual button 1101. By doing so, it is possible to skip the service mode screen transition flow shown in FIG. 5 and transition directly to the desired service mode screen.

FIG. 13 is a flowchart showing a flow of processing regarding a screen transition from the service manual to the service mode on the maintenance service terminal 105. Prior to the start of this flow, the worker is authenticated and logs into the maintenance service terminal 105 or logs into the maintenance assistance system through the terminal. The procedure in FIG. 13 is realized by the maintenance service terminal 105, or more specifically, by the CPU 201 thereof executing a program stored in a memory such as the RAM 202. However, in the following description, the software modules shown in FIG. 3 will be described as the entities that execute each step. Note that steps S1301 and S1302, S1304 to S1306, and S1308 to S1311 of FIG. 13 are the same as steps S901 and S902, S904 to S906, and S908 to S911 in FIG. 9, respectively, and therefore some of the description of those steps is omitted.

First, in step S1301, the service manual viewer 303 displays the service manual on the maintenance service terminal 105 in response to an operation performed by the maintenance worker. Next, the maintenance worker selects the service mode link 706 on the displayed service manual to perform work in the service mode. When the service mode link 706 is selected, in step S1303, the service manual display control unit 301 acquires the coordinate information 1203 of the virtual button 1101 from the transition destination definition table 1200 in FIG. 12. In this example, it is assumed that a maintenance worker whose role is CE has selected “link2” in the service manual “ServiceManual¥001¥PageB”, and (100, 200) is acquired as the coordinate information. Next, in step S1304, the service manual display control unit 301 requests the image forming apparatus 101 to activate the service mode via the command issuing unit 304 in order to perform a screen transition in the service mode. At the same time, the service manual display control unit 301 instructs the service manual viewer 303 to display a screen indicating that processing is in progress.

In step S1305, the VNC client 305 is activated and a VNC connection with the VNC server 404 is started. In step S1306, the service manual display control unit 301 performs sleep processing to wait for the service mode activation of the image forming apparatus 101 after step S1305.

In step S1307, the service manual display control unit 301 issues a mouse event indicating that a virtual button has been clicked to the image forming apparatus 101 via the VNC client 305. At this time, the screen to be transitioned to is designated by setting the coordinate information 1203 of the virtual button 1101 acquired in step S1303 as the clicked coordinates. Upon receiving the mouse event, the image forming apparatus 101 recognizes that a virtual button “Button06” located at the click coordinates (100, 200) of the mouse event on the virtual screen 1100 has been pressed. Then, control is performed so as to perform a screen transition to “Screen1104a” defined in the transition destination definition 1110, which is the processing assigned to the virtual button. In step S1308, the service manual display control unit 301 performs sleep processing to wait for the screen transition of the image forming apparatus 101 after step S1307. In step S1309, screen sharing via a VNC connection is started, and the service mode screen “Screen1004a” displayed on the image forming apparatus 101 is displayed on the display unit 209 of the maintenance service terminal 105. Steps S1310 to S1311 are the same as steps S910 to S911 in FIG. 9.

Next, referring again to FIG. 10, the screen flow in the second embodiment will be described in conjunction with the steps in FIG. 13. First, the screen 700 in FIG. 10 is a screen displaying the service manual described with reference to FIG. 7, and is displayed when the maintenance worker opens the service manual on the maintenance service terminal 105 in step S1301. The maintenance worker performs the work while referring to the resolution method 702 in the displayed service manual, and selects the service mode link 706 when performing the work in the service mode of the image forming apparatus 101. Next, in step S1303, in response to the service manual display control unit 301 instructing the service manual viewer 303 to display a screen indicating that processing is in progress, this processing screen 1001 is transitioned to.

Next, the screen 540 in FIG. 10 is the service mode screen “Screen 1004a” for the CE described in FIG. 5, and is a screen that requires the CE to perform work such as starting a part replacement sequence and inputting adjustment value parameters. In step S1309, screen sharing via VNC with the VNC server 404 starts, and the screen transitions to this service mode screen 540. If the role of the maintenance worker who selected the link in step S1302 is MS, the coordinate information acquired in step S1303 is (150, 200), and a mouse event of these coordinates is issued to the image forming apparatus 101 in step S1307. As a result, the image forming apparatus 101 performs processing for a screen transition to “Screen 1004b” assigned to the virtual button “Button07”. This causes a screen transition from the service manual screen 700 to the service mode screen 550, which is the service mode screen “Screen 1004b” for the MS.

Finally, when the maintenance worker finishes working on the service mode screen and selects CLOSE, the VNC connection is ended. By doing so, the VNC screen on the display unit 209 of the maintenance service terminal 105 is closed, and the display returns to the service manual screen 700 that was displayed before the service mode link 706 was selected.

With the above configuration and procedure, the link embedded in the service manual is associated with the service mode screen of the image forming apparatus. The associated service mode screen is then shared with the terminal and displayed on the terminal using, for example, a remote desktop function. This enables a seamless transition from the service manual to the operation screen of the image forming apparatus, even if the apparatus on which a service tool for maintenance assistance, such as a service manual viewer, is installed is different from the image forming apparatus. This provides an environment in which maintenance work can be performed efficiently.

Furthermore, depending on the role and authority associated with the maintenance worker, the transition destination operation screen associated with the link selected in the service manual can be set. This makes it possible to guide the maintenance worker to maintenance work appropriate for his or her role or authority, and enables the maintenance work to be performed efficiently and without error.

Furthermore, in this embodiment, in the maintenance service terminal, the link embedded in the service manual is associated with the position of the virtual button, and in the image forming apparatus, the virtual button is associated with the transition destination screen. When a link is selected, the position of the associated virtual button is designated as the transition destination and the image forming apparatus is caused to share the screen, allowing the terminal to share many screens associated with the virtual button with the image forming apparatus. Accordingly, the screen to be shared can be selected by designating a parameter (i.e., coordinates) of one command, and the configuration of the command reception unit 403 can be simplified.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-041587, which was filed on Mar. 15, 2024 and which is hereby incorporated by reference herein in its entirety.

What is claimed is:

1. An information processing apparatus configured to cooperate with an image forming apparatus, comprising:
a display;
a storage holding a role of a worker during work;
at least one memory storing instructions; and
at least one processor that is in communication with the at least one memory and that, when executing the instructions, cooperates with the at least one memory to execute processing, the processing including
issuing an instruction, in response to selection of an item that is included in a manual displayed by the display and is associated with a maintenance screen of the image forming apparatus displayed by the image forming apparatus on a display of the image forming apparatus, to the image forming apparatus to transmit screen information of the maintenance screen associated with the item for each role of the worker who performed the selection; and
displaying the maintenance screen on the display based on the screen information transmitted by the image forming apparatus in response to the instruction.

2. The information processing apparatus according to claim 1,
further comprising a remote operation client for a remote operation server of the image forming apparatus,
wherein the remote operation client transmits an instruction to the image forming apparatus in response to an operation performed on the maintenance screen displayed on the display.

3. The information processing apparatus according to claim 1,
wherein the maintenance screen and the item are associated with each other by a command corresponding to each maintenance screen held by the image forming apparatus and a command instructed to the image forming apparatus by the instruction.

4. The information processing apparatus according to claim 1,
wherein the maintenance screen and the item are associated with each other by a virtual button corresponding to each maintenance screen held by the image forming apparatus, and a virtual button that is associated with the item and is instructed to the image forming apparatus by the instruction.

5. The information processing apparatus according to claim 4,
wherein the virtual button is not displayed by the image forming apparatus.

6. The information processing apparatus according to claim 1,
wherein the processing further includes acquiring, from a server, the manual and information regarding an association between the item included in the manual and the maintenance screen,
wherein the instruction instructs the image forming apparatus to transmit the maintenance screen associated with the information in response to a selection of the information from the manual that is displayed on the display and was acquired by the acquiring.

7. The information processing apparatus according to claim 1,
wherein the displaying includes re-displaying the manual in response to an operation of closing the maintenance screen.

8. The information processing apparatus according to claim 1,
wherein the maintenance screen is a screen for a user to perform maintenance and inspection of the image forming apparatus.

9. A non-transitory computer-readable storage medium storing computer-executable instructions that cause a computer configured to cooperate with an image forming apparatus to execute processing when the computer-executable instructions are loaded into and executed by the computer, the processing including:
issuing an instruction, in response to selection of an item that is included in a manual displayed by a display and is associated with a maintenance screen of the image forming apparatus displayed by the image forming apparatus on a display of the image forming apparatus, to the image forming apparatus to transmit screen information of the maintenance screen associated with the item for each role of a worker who performed the selection; and
displaying the maintenance screen on the display based on the screen information transmitted by the image forming apparatus in response to the instruction.

10. A maintenance-assistance method to be performed by an information processing apparatus configured to cooperate with an image forming apparatus and including a display and a storage holding a role of a worker during work, the maintenance-assistance method comprising:
issuing an instruction, in response to selection of an item that is included in a manual displayed by the display and is associated with a maintenance screen of the image forming apparatus displayed by the image forming apparatus on a display of the image forming apparatus, to the image forming apparatus to transmit screen information of the maintenance screen associated with the item for each role of the worker who performed the selection; and
displaying the maintenance screen on the display based on the screen information transmitted by the image forming apparatus in response to the instruction.
